(19) United States
(12) Patent Application Publication
(10) Pub. No.: US 2008/0198576 A1
(43) Pub. Date: Aug. 21, 2008

(54) Method and device for lighting vessels

(76) Inventors: Ari Eliaz, Tel Aviv (IL); Shmuel Shaki, Tel Aviv (IL); Yosef Aharoni, Tel Aviv (IL); Eliyahou Gabay, Lahavim (IL)

Correspondence Address: UZI EZRA HAVOSHA & PARTNERS, HADAR-DAFNA HOUSE 39 SHAOUL HAMELECH STREET, TEL AVIV, 64928, omitted

(21) Appl. No.: 11/707,478

(22) Filed: Feb. 20, 2007

(51) Int. Cl. F21V 33/00

(52) U.S. Cl. 362/101; 40/442

(57) ABSTRACT

Imbedded in glass vessels like drinking glasses and bottles an electronic device that shines when the glass vessel is moved. The rays of light would travel through the thickness of the glass and/or through the liquid therein. The electronic device is powered by a battery and the movement of the vessel closes an electronic circuit which turns on the light. When the vessel is stationary the electrical circuit is broken so that the light would switch off. The bulb could be a led type or other low power user. There could be a switch accessible from outside the vessel to turn off the possibility of the light shining. In another embodiment the battery, light and other apparatus of this invention would be in an independent base into which a glass vessel would stand. The light effect would be similar as described above when the vessel and the base are tilted and/or otherwise moved.

### FIELD OF THE INVENTION

This invention is in the field of aesthetics and gimmick. More specifically a glass vessel is lit by a bulb when it is moved and the light switches off when the vessel is stationary. The light in the vessel shines through the thickness of the glass spreading the light throughout the vessel and through the drink.

### BACKGROUND OF THE INVENTION

Prior art in this field shows a number of ways of lighting glasses or bottles but using different methods from the present invention. For example, US patent application number 2006109644 applied for by Saucier et al. reveals a method of lighting bottles for advertising by illuminating silk screening. The method of operating the lighting is with the aid of an on-off switch. As will be revealed herein the purpose of the lighting and method of switching on the light of the present invention is very different. In US patent application number 2006139928 applied for by Griffiths et al. reveals a method of lighting bottles of drink where the lighting is switched on by opening the bottle. The purpose is to detect when the bottle has been opened and then operate the light.

This invention reveals a different purpose and method of operating the lighting system. The purpose is to promote sales by creating a gimmick which also has aesthetic elements. The invention shows ways to light up the walls and contents of a bottle when the bottle is moved and to light up drinking glasses and their contents when they are moved or tilted for example when raising glasses for a toast or drinking.

### SUMMARY OF THE INVENTION

It is to be understood that both the foregoing general description and the following detailed description present embodiments of the invention, and are intended to provide an overview, or framework, for understanding the nature and character of the invention as it is claimed. The accompanying drawings are included to provide a further understanding of the invention, and are incorporated into and constitute a part of this specification. The drawings illustrate various embodiments of the invention and, together with the description serve to explain the principles and operations of the invention.

This invention comprises an electrical power source, a light producing source and electrical connectors set up in such a way that the electrical circuit will be completed causing the light source to produce light when one of the designated events occur.

The electrical power source could be a small battery. The light source could be a light emitting diode (led) as it uses relatively small amounts of current thereby enabling the battery to supply electricity for longer periods.

The electrical connectors could be wires and metal strips placed and connected in such a way that when the electrical circuit is complete the light will shine. The final connecting element in the electrical circuit could be a metal ball and when the ball rests in a slight depression the circuit is not complete but when it is moved out of the depression to touch the edge of its enclosure it will complete the electrical circuit and light the light source.

The above mentioned apparatus and components would be installed into the base of a bottle or the base of a drinking glass. The components could utilize the indentation sometimes made in the base of bottles and drinking glasses. Alternatively they could be imbedded in the body of the material of the walls or base of the bottle or in the base of the drinking glass. Another alternative embodiment of this invention is to have a base piece into which the bottle or glass would stand. The above mentioned apparatus and components would be installed into the said base so that the light effects would be similar to those described in relation to the previous embodiments. Bottles and drinking glasses made of glass, plastic and other transparent, semi-transparent or translucent materials would be suitable to work with this invention, so that the light emitted will be seen in all or part of the thickness of the walls of the bottles and glasses. The light also may be seen reflected or refracted in the liquid.

This effect of using a metal ball to complete the circuit enables the light to remain off when the bottle or glass is stationary. When the bottle or glass is lifted, tilted or otherwise moved the metal ball would be moved out of the depression and move to the extremities of the enclosure where it is kept whereupon it will touch the electrical connectors and complete the electrical circuit.

The degree of movement or tilt required to move the metal ball out of its depression could be adjusted by making the depression with different depths. Where it is desired to light the light only when pouring liquid out of the bottle, the depression would be made deeper than where it is desired for example, for the light to light at the mere raising of a drinking glass. In the latter case a slight movement of the glass even without tilting it for drinking purposes, would dislodge the metal ball from its slight depression to touch the wired edges and thereby make the electrical connection.

### BRIEF DESCRIPTION OF THE DRAWINGS

The accompanying drawings, which are incorporated in and form a part of this specification, illustrate embodiments of the invention and, together with the description, serve to explain, by way of example only, the principles of the invention:

FIG. 1 is a schematic depiction from the section view of a ball on a surface with a depression.

FIG. 2 is a schematic depiction from the plan view of the said surface.

FIG. 3 is a schematic depiction from the section view of the lower end of a bottle that has an indentation in its base with the components of this invention in the indentation.

FIG. 4 shows how this invention could be placed in the base of a drinking glass.

FIG. 5 is an electrical circuit diagram of this invention.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

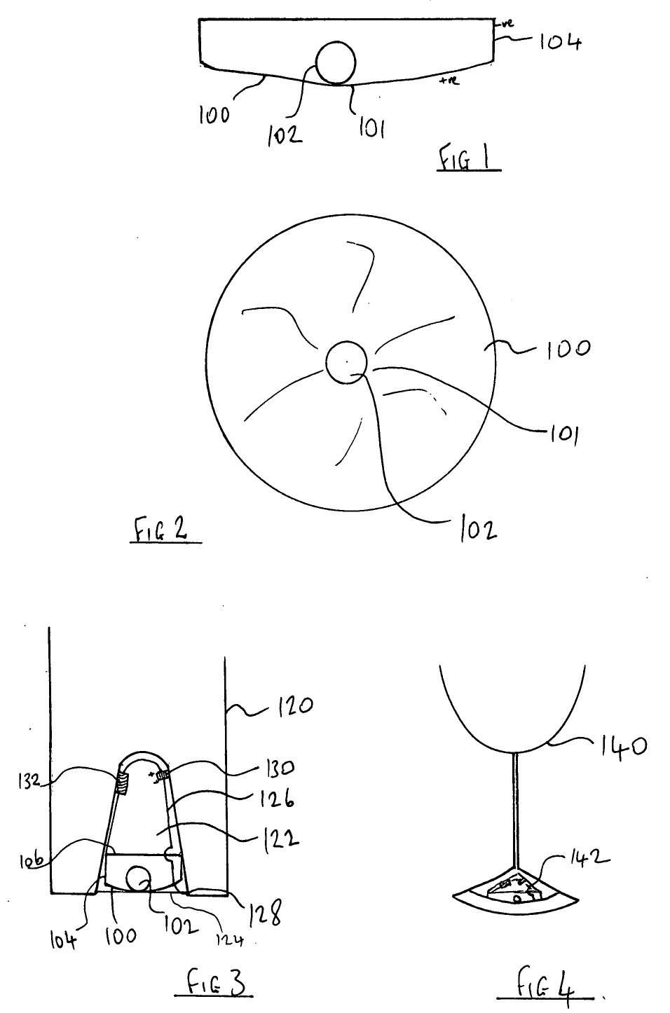

FIG. 1 shows the section view of the surface 100 on which the metal ball 102 rests. The surface 100 has a depression 101 so that the ball will not move to the sides 104 without a given amount of movement or tilt. The surface 100 is made of an electrical conducting substance and is connected to one side of the electrical circuit, for example, the positive charge. When the ball 102 is in the depression the electrical circuit is incomplete. The sides 104 are connected to the other side of the electrical circuit for example the negative charge and so if the ball 102 touches the sides 104, the ball 102 itself becomes a part of the electrical circuit as electricity passes through the ball 102 to the surface 100 thereby completing the circuit thereby causing the light to shine.

FIG. 2 shows the surface 100 from the plan view. The ball 102 is resting in the depression 101 of the surface 100.

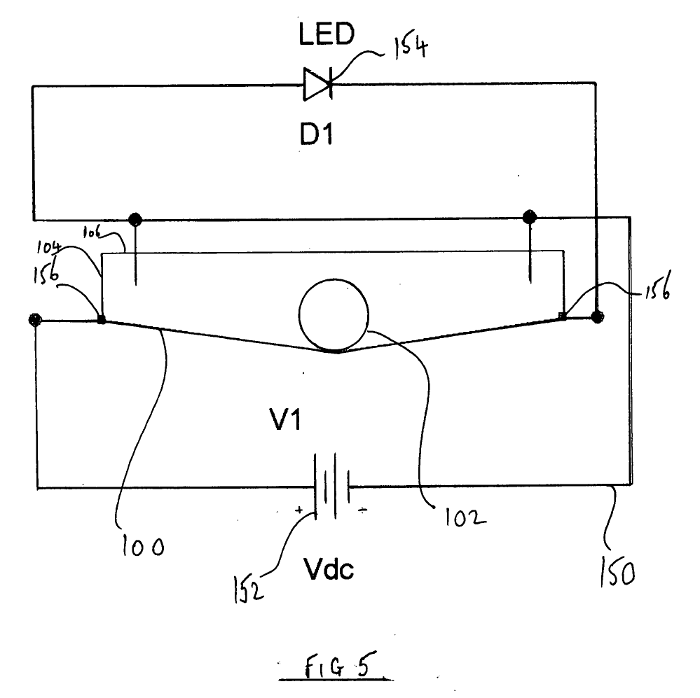

FIG. 3 shows the section view of the lower end of a bottle 120 that is manufactured with an indentation 122 in its base. This indentation 122 is utilized to house the components of this invention. The opening at the base of bottle 120 is closed with a substance 124 to support the elements above it. The metallic ball 102 is resting in the depression of surface 100. The surface 100 is connected to only one side of the electrical circuit 126 at point 128. The battery 130 is part of the circuit 126 and so is the led light 132. The other side of the circuit 126 is connected to the sides 104 and covering 106 of the enclosure of the ball 102.

When the ball 102 is resting in the depression of the surface 100 the electrical circuit is not complete. When the bottle 120 is tilted, the ball 102 moves and touches the side 104 and/or the covering 106 thereby completing the electrical circuit 126 and the led light 132 or lights will shine.

FIG. 4 shows a diagram of the elements 142 of this invention in the base of a drinking glass 140.

FIG. 5 shows an electrical circuit diagram 150. The power source or battery 152 is shown with its positive and negative polarities. The plus side of the circuit is connected to the surface 100 with a depression in it. The ball 102 is resting in the depression. The minus side of the circuit is connected to the led light 154 and to the walls 104 and cover 106 of the enclosure of ball 102. The connections 156 are insulated to prevent electricity from flowing and completing the electrical circuit. Only the ball 102 can complete the circuit by touching the surface 100 and the walls 104 or cover 106 at the same time.

What is claimed:

1. A method and device for lighting bottles and drinking glasses (referred to in these claims as “vessels”) using an electrical circuit comprising:
a) a surface with a depression in it being on one side of the said circuit,
b) a source of electrical energy,
c) a source of light emission,
d) at least one metallic ball that rests on the said surface being enclosed by metallic sides and a cover being the other side of the said circuit, and
e) a means to attach the said circuit and its accompaniments to vessels,
whereby the said source of light emission will emit light when the said ball touches both the said surface and said metallic sides thereby completing the electrical circuit as the electricity from the said source of electrical energy flows from the said one side of the said circuit through the said ball to the other side of the said electrical circuit.

2. A method and device as claimed in claim 1 wherein the said source of electrical energy is at least one battery.

3. A method and device as claimed in claim 1 wherein the said source of light emission is at least one light emitting diode.

4. A method and device as claimed in claim 1 wherein the said electrical circuit is at least partially attached in the hollow base of a bottle.

5. A method and device as claimed in claim 1 wherein the said electrical circuit is at least partially attached in the hollow base of a drinking glass.

6. A method and device as claimed in claim 1 wherein the said electrical circuit is at least partially imbedded in the walls of the said vessel.

7. A method and device as claimed in claim 1 wherein the said electrical circuit has a switch which when switched on will enable the said ball to complete the said circuit when it touches the said metallic sides and when switched off will prevent the completion of the said circuit even when the said ball touches the said metallic sides.

8. A method and device as claimed in claim 7 wherein the said switch is exposed to the external surface of the said vessel even though rest of the said electrical circuit is at least partially embedded in the walls of the said vessel.

9. A method and device as claimed in claim 1 wherein the said electrical circuit is completed when the said vessel is moved.

10. A method and device as claimed in claim 1 wherein the said electrical circuit is completed when the said vessel is raised.

11. A method and device as claimed in claim 1 wherein the said electrical circuit is completed when the said vessel is tilted.

12. A method and device as claimed in claim wherein the said surface has an adjustable degree of depression so that the degree of movement and tilt, causing the said metallic ball touch the said metallic sides, will change accordingly.

13. A method and device as claimed in claim 1 further comprising a base into which the said vessels stand and in which the said circuit and electrical accompaniments is contained and positioned in such a way that when the said vessels are tilted or otherwise moved the said base tilts or moves and the said metallic ball completes the said electrical circuit and the said light is emitted.

14. A method and device as claimed in claim 13 wherein the at least two of the said vessels are interchangeably placed in the said base.

15. A vessel made of at least partially transparent material and made to contain liquids has attached to it an electrical circuit comprising:
a) a surface with a depression in it being on one side of the said circuit,
b) a source of electrical energy,
c) a source of light emission,
d) at least one metallic ball that rests on the said surface being enclosed by metallic walls and a cover being on the other side of the said circuit, and
e) a means to attach the said circuit and its accompaniments to the said vessel,
whereby the said source of light emission will emit light into the walls of the said vessel and into liquid contained the said vessel when the said ball touches both the said surface and said metallic sides thereby completing the electrical circuit as the electricity from the said source of electrical energy flows from the said one side of the said circuit through the said ball to the other side of the said electrical circuit.

16. A vessel as claimed in claim 15 wherein the said source of electrical energy is at least one battery.

17. A vessel as claimed in claim 15 wherein the said source of light emission is at least one light emitting diode.

18. A vessel as claimed in claim 15 wherein the said vessel is a bottle.

19. A vessel as claimed in claim 15 wherein the said vessel is a drinking glass.

20. A vessel as claimed in claim 15 wherein the said electrical circuit is at least partially imbedded in the walls of the said vessel.

21. A vessel as claimed in claim 15 wherein the said electrical circuit has a switch which when switched on will enable the said ball to complete the said circuit when it touches the said metallic sides and when switched off will prevent the completion of the said circuit even when the said ball touches the said metallic sides.

22. A vessel as claimed in claim 21 wherein the said switch is exposed to the external surface of the said vessel even though rest of the said electrical circuit is at least partially embedded in the walls of the said vessel.

23. A vessel as claimed in claim 15 wherein the said electrical circuit is completed when the said vessel is moved.

24. A vessel as claimed in claim 15 wherein the said electrical circuit is completed when the said vessel is raised.

25. A vessel as claimed in claim 15 wherein the said electrical circuit is completed when the said vessel is tilted.

26. A vessel as claimed in claim 15 wherein the said surface has an adjustable degree of depression so that the degree of movement and tilt, causing the said metallic ball touch the said metallic sides, will change accordingly.

27. A base that acts as a base for vessels that have attached to the said base an electrical circuit comprising:
a) a surface with a depression in it being on one side of the said circuit,
b) a source of electrical energy,
c) a source of light emission,
d) at least one metallic ball that rests on the said surface being enclosed by metallic walls and a cover being on the other side of the said circuit, and
e) a means to attach the said circuit and its accompaniments to the said base,
whereby the said source of light emission will emit light into the walls of the said vessels and into liquid contained the said vessels when the said ball touches both the said surface and said metallic sides thereby completing the electrical circuit as the electricity from the said source of electrical energy flows from the said one side of the said circuit through the said ball to the other side of the said electrical circuit.

28. A base as claimed in claim 27 wherein the said vessels can interchangeably use the said base as their base.

29. A base as claimed in claim 27 wherein the said source of light emission is at least one light emitting diode.

30. A base as claimed in claim 27 wherein the said surface has an adjustable degree of depression so that the degree of movement and tilt, causing the said metallic ball touch the said metallic sides, will change accordingly.
